(19) United States
(12) Patent Application Publication
(10) Pub. No.: US 2024/0390799 A1
(43) Pub. Date: Nov. 28, 2024

(54) Systems and Methods for Tick-Less UDP Game Traffic

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/669,729

(22) Filed: May 21, 2024

Related U.S. Application Data
(60) Provisional application No. 63/503,569, filed on May 22, 2023.

(51) Int. Cl. A63F 13/69; A63F 13/52

(52) U.S. Cl. CPC A63F 13/69; A63F 13/52

(57) ABSTRACT

Systems and methods for communicating and synchronizing game state data for online games are described herein. A game server described herein may be configured to use predictive coding to provide game state data that includes all the information necessary to calculate a position of an object at a future point in time. If the movement of the object indeed does not change, the game server may forego publishing an update to the data related to that object. Instead, the client computer system may be configured to render the object based on the information already received. In some implementations, the published game state data may be included within User Datagram Protocol (UDP) packets. In some implementations, the game state data may be published by the game server immediately in response to input received. For example, the game state data may be published without waiting for a subsequent network tick.

### RELATED APPLICATIONS

This application claims priority to U.S. Provisional Application No. 63/503,569, entitled “Method for Optimizing UDP Game Traffic,” filed on May 22, 2023, the content of which is hereby incorporated herein by reference in its entirety.

### FIELD OF THE DISCLOSURE

The systems and methods described herein relate to improved techniques for communicating game state data for online games.

### BACKGROUND

In three-dimensional online games, various game assets are frequently used to express computer-generated graphics or three-dimensional models. Game assets may include different three-dimensional objects such as characters, items, cars, furniture, buildings, or other structures. Most of the time, game assets are incorporated into the three-dimensional online games and are downloaded when players decide to purchase games. As the complexity and detail of game assets in online games increases (for example, to accommodate the use of augmented or virtual reality), maintaining an adequate download and loading-to-screen time becomes increasingly difficult. Indeed, as the size of the files needed to render game assets increases, so too does transmission data size, transmission time, memory usage, and rendering time.

A game's choice of transport layer protocol (and its management and coding) can affect perceived networking issues. For example, if a game uses Transmission Control Protocol (TCP), certain guarantees may be provided to the application level at the expense of increased latencies when one or more of the IP packets are lost. On the other hand, if a game uses User Datagram Protocol (UDP), latencies and overheads may be lower but unlike TCP, “reliable stream” guarantees will not be provided. Given the importance of latencies for online gaming (and that any guarantees, if necessary, can be provided over UDP too, albeit at significant development cost), UDP is often used in online games instead of TCP. Nevertheless, merely using UDP does not necessarily guarantee minimizing latencies for the online gamer. For example, if application emulates TCP over UDP, it will suffer from the same latency issues as TCP. More generally, any implementation (regardless of being UDP-based) that provides reliable ordered stream guarantees is bound to suffer from so-called “Head-of-Line Blocking” (HOL blocking), which is one of the main factors for latency increase when a packet is lost. As a result, there is constantly a need to identify techniques for communicating and synchronizing game state data for online games that provide certain easy-to-understand-and-use guarantees while ensuring better latencies when facing packet loss and reducing traffic.

### SUMMARY OF THE DISCLOSURE

This disclosure relates to systems and methods for communicating and synchronizing game state data for online games. According one aspect of the invention, the systems and method described herein may be configured to improve the communication of game state data used to render three-dimensional objects within a virtual scene. In various implementations, a game server may be configured to use predictive coding to provide game state data that includes all the information necessary to calculate a position of an object at a future point in time. For example, game state data provided by a game server to a client computer system may include at least coordinate data and velocity data for an object at a given point in time. In some implementations, the game state data may further include a target point and one or more next points each representing a subsequent point that the object will traverse after the target point unless updated game state data is received. Using the received game state data and one or more velocity profiles associated with the object, the client computer system may be configured to calculate a position of an object at a future point in time provided the movement of the object does not change. Accordingly, the game server may be configured to determine whether, at a later time (e.g., at a subsequent simulation tick), whether the movement of the object has changed necessitating an update to the data related to that object. If the movement of the object has not changed, the game server may not publish an update to the data related to that object. Instead, the client computer system may be configured to render the object based on the information already received.

In some implementations, the game state data may be included within one or more User Datagram Protocol (UDP) packets. In some implementations, the updated game state data may be encoded by reference to a last received and/or acknowledged version of the game state data. In some implementations, the game state data may be published by the game server immediately in response to input received. For example, the game state data may be published by the game server immediately in response to input that prompts the game state data to be updated. In some implementations, publishing the game state data immediately may comprise publishing the game state data without waiting for a subsequent network tick. For those implementations described herein in which game state data is published without any relation to network ticks, but rather in response to input or to some simulation change (such as collision detected by a simulation), such implementations may be referred to as “tick-less game state publications” or “tick-less UDP game traffic.” Such “tick-less” publishing may both improve latencies (as there is no need to wait for the next network tick to publish input) and reduce traffic (as there is no need to send any data if nothing has changed).

According to another aspect of the invention, the systems and methods described herein may be configured to improve the synchronization of the receipt of game state data with the rendering of a virtual scene based on the received game state data. In various implementations, a client computer system may be configured to receive updated game state data from a game server to be used to render a virtual scene within an online game. In various implementations, the client computer system may be configured to pass a server time associated with the updated game state data to a phase-locked loop (PLL). Unlike traditional PLLs used in hardware design, a PLL used within a game client (i.e., on a client computer system) may be implemented entirely in software. In some implementations, the phase-locked loop may be implemented at least in part by a phase comparator, a loop filter, and a numerically controlled oscillator (NCO). In various implementations, a virtual delay may be used to account for uneven packet sending, which may result from skipping some network ticks (or abolishing them entirely). For example, the virtual delay may be based on a difference between the server time associated with the updated game state data and a time corresponding to a next well-defined moment within the online game (which can be thought of as a “virtual network tick,” even though no packets may be sent at the time of such a virtual tick).

In some implementations, the server time associated with the updated game state data may be delayed based on the virtual delay prior to being provided to the phase-locked loop. In other implementations, the phase-locked loop may be configured to treat the packet as delayed based on the virtual delay. In some implementations, synchronization of the receipt of the updated game state data with the rendering of the virtual scene may be sped up by syncing output of the NCO with an initial set of packets or by increasing an impact of an output of the phase comparator on the loop filter for an initial set of packets. Using an output of the phase-locked loop, the client computer system may be configured to calculate a game server time as seen on the client computer system (i.e., server-T for the client-side).

In some implementations, whenever a scene has to be rendered on the client computer system, the client computer system may be configured to determine “server-T,” which corresponds to the moment of rendering. In some implementations, the moment (or time) of rendering may be determined using vertical synchronization (V-sync). In some implementations, a correspondence between the moment of rendering and the moment of server-T may be determined using PLL. Once the game time as seen on the client computer system is determined, that time may be used to render a virtual scene based on the updated game state data and the game time as seen on the client computer system. In some implementations, current coordinates of the objects in the virtual scene may be calculated based on server-T, published data (such as object coordinates and velocities), and some static data (such as velocity profile(s)). In various implementations, rendering the virtual scene based on the updated game state data and the game time as seen on the client computer system at the time of rendering may comprise calculating coordinates for an object based on the game time as seen on the client computer system and rendering the object within the virtual scene based on the calculated coordinates.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to communicate game state data used to render three-dimensional objects within a virtual scene, according to one or more aspects described herein;

FIG. 2 depicts a block diagram of example information downloadable from a game server and associated with a particular game object or type of game object, according to one or more aspects described herein;

FIG. 3 depicts a block diagram of an example client application used to synchronize a game state between a game server and a client computer system, according to one or more aspects described herein;

FIG. 4 depicts a diagram of an example of a method for communicating game state data used to render three-dimensional objects within a virtual scene, according to one or more aspects described herein;

FIG. 5 depicts a diagram of an example of a method for updating a game state based on information related to a moving object received from a game server, according to one or more aspects described herein; and

FIG. 6 depicts a diagram of an example of a method for syncing the receipt of game state data with the rendering of a virtual scene based on the received game state data, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

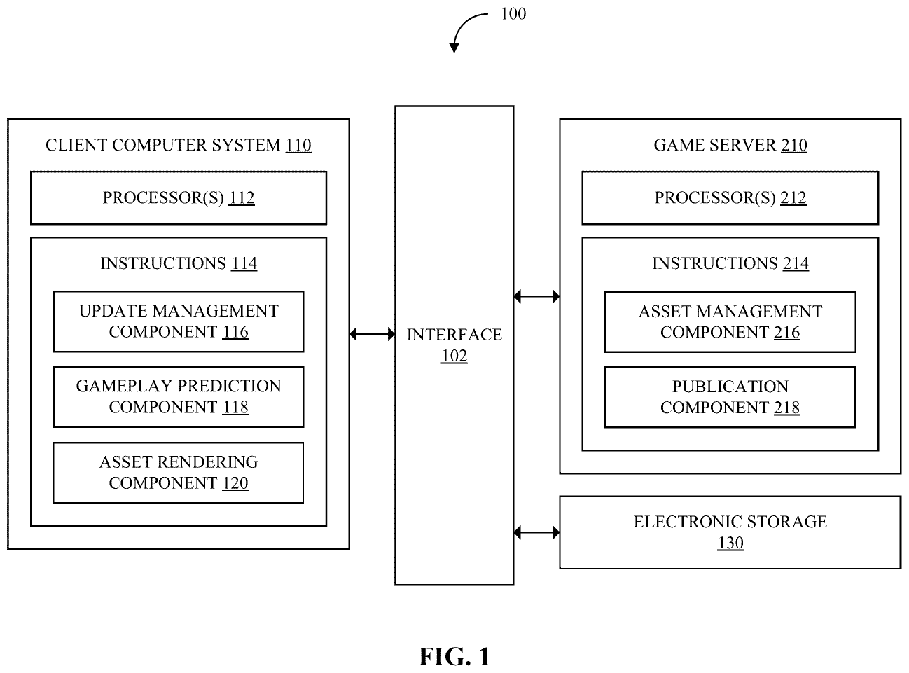

FIG. 1 depicts a block diagram of an example of a system 100 configured to communicate game state data from a game server to a game client, according to one or more aspects described herein. In various implementations, the game state data may be used to by the game client to render three-dimensional objects within a virtual scene in an online game. Notably, while “three-dimensional objects” are referred to herein, the techniques described herein may apply equally to “two-dimensional objects.” As such, all references herein to “three-dimensional objects” may be replaced with “two-dimensional objects.” In various implementations, system 100 may include one or more of an interface 102, at least one client computer system 110, electronic storage 130, a game server 210, and/or other components. In various implementations, client computer system (or device) 110 may comprise a game client computing system (or device). In some implementations, client computer system 110 may be configured to receive instructions and/or game state data related to an online game comprising three-dimensional virtual scenes from game server 210. In various implementations, client computer system 110 may include one or more physical processors 112 (also interchangeably referred to herein as processor(s) 112, processor 112, or processors 112 for convenience), computer readable instructions 114, and/or one or more other components. In various implementations, game server 210 may include one or more physical processors 212 (also interchangeably referred to herein as processor(s) 212, processor 212, or processors 212 for convenience), computer readable instructions 214, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 210.

In various implementations, processor(s) 112, 212 may be configured to provide information processing capabilities in system 100. As such, the processor(s) 112, 212 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112, 212 may be configured to execute one or more computer readable instructions 114, 214. Computer readable instructions 114, 214 may include one or more computer program components. In various implementations, computer readable instructions 114 may include one or more of update management component 116, gameplay prediction component 118, asset rendering component 120, and/or one or more other computer program components, and computer readable instructions 214 may include one or more of asset management component 216, publication component 218, and/or other computer program components. As used herein, for convenience, the various computer readable instructions 114, 214 will be described as performing an operation, when, in fact, the various instructions program the processor(s) 112, 212 (and therefore client computer system 110 or game server 210) to perform the operation.

In various implementations, client computer systems 110 may subscribe to receive game updates from a game server 210 related to an online game. For example, game server 210 may “publish” game state, and one or more of client computer system 110 may “subscribe” to receive the published game state. As a result of such a “subscription” by a client computer system 110, game server 210 may (a) send client computer system 110 a current game state, (b) include client computer system 110 (identified, for example, by its IP address and/or network socket which is used to communicate with client computer system 110) on a list of “subscribers” for this “publication”, and (c) whenever published game state is updated (for example, as a result of user inputs sent to the game server and/or as a result of simulation), game server 210 may send the update to the game state to all the current “subscribers”. In response to the updated game state data and/or as otherwise necessary, client computing system 110 may be configured to download game assets from game server 210 for rendering within virtual scenes of the game. To that end, in various implementations, asset management component 216 may be configured to generate, organize, encode, and/or otherwise manage game assets used to render a virtual scene. For example, game assets may comprise the three-dimensional objects that, when rendered, make up a virtual scene in a game.

In various implementations, asset management component 216 may be configured to save digital assets. For example, to do so, in various implementations, asset management component 216 may be configured to utilize any of the one or more compression methods described in U.S. patent application Ser. No. 18/630,409, entitled “SYSTEMS AND METHODS FOR INCREMENTAL DYNAMIC LOADING OF GAME ASSETS,” filed Apr. 9, 2024, the contents of which are hereby incorporated by reference herein in their entirety. In some implementations, asset management component 216 may be configured to utilize any of the one or more compression methods described in U.S. patent application Ser. No. 18/630,409, with minor modifications. In various implementations, asset management component 216 may be configured to save digital assets in a “decompression-friendly” format. For example, when compressing a texture, the “decompression-friendly” format may comprise a modified version of JPEG or JPEG XL format (or any other format from the JPEG family), as described in U.S. patent application Ser. No. 18/630,409.

In various implementations, publication component 218 may be configured to publish data regarding a current state of the game. In various implementations, publication component 218 may be configured to use mechanisms such as Unity sync variables, UE4 variable replication, or ZeroMQ or global-mq “publications.” In various implementations, a publication may include one or more of the following: a current level, list of items and/or non-player characters (NPCs) with identifiers for their three-dimensional models and/or their coordinates. In some implementations, a publication may be compressed using compression methods for structured data. For example, a given publication may be compressed using one or more techniques described in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, the content of which is hereby incorporated by reference herein in its entirety.

In various implementations, publication component 218 may be configured to use UDP as a transport protocol to synchronize “subscription” on the client-side (i.e., at client computer systems 110) with a “publication” on the server-side (i.e., at game server 210). In some implementations, publication component 218 may be configured to send updated game state data (or “updates”) as “publication” within UDP packets. In such implementations, publication component 218 may be configured to send updated game state data within UDP packets at regular intervals. The moments of such updates (i.e., at regular intervals) may be referred to as a “network ticks.” Typically, movements are simulated within an online game at the same time that an update is published. The moments when movements are simulated within an online game may be referred to as “simulation ticks.” Typically, “simulation ticks” occur at the same time as “network ticks.” In some implementations, however, simulation ticks may occur at a different frequency than network ticks. For example, there may be several simulation ticks per network tick. Moreover, as described herein, there may be implementations without network ticks (“tick-less game state publications”) while simulation ticks may still be present.

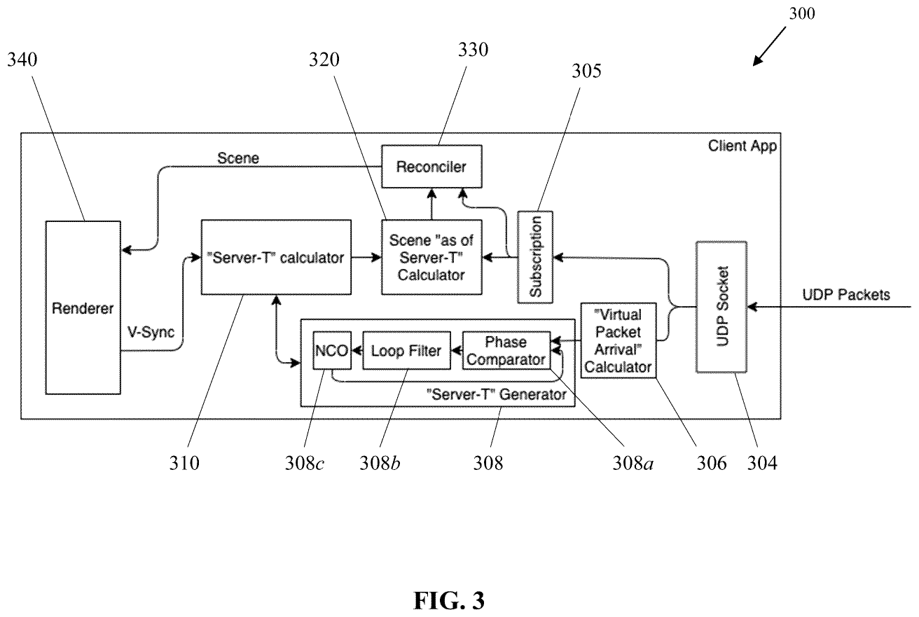

In various implementations, update management component 116 may be configured to manage updates and other information received by client computer system 110 from game server 210. In various implementations, gameplay prediction component 118 may be configured to predict (or calculate) information (such as the coordinates or velocity) of an object based on information received from game server 210. In various implementations, asset rendering component 120 may be configured to render game assets within a virtual scene. In some implementations, some or all of the functionality of update management component 116, gameplay prediction component 118, asset rendering component 120 may be implemented by or otherwise described with respect to client application 300 depicted in FIG. 3 and described further herein.

In various implementations, publication component 218 may be configured to update a “published game state,” which may involve sending updated game state data (for example, by sending UDP packet(s)) at irregular intervals. For example, publication component 218 may not update a publication at a regular interval (such as at a “network tick”), but may instead update a publication whenever it becomes necessary. In some such implementations, publication component 218 may be configured to send updated game state data on a simulation tick, in response to inputs coming from users, in response to inputs coming from artificial intelligence or other CPU-controlled entities (collectively referred to herein as “AI”), on timer events happening at pre-defined intervals following inputs from players and/or AI, and/or in response to other events. In some implementations, updates sent on simulation may be further filtered based on changes in game state (i.e., if there were no changes in published data, or if the changes are relatively small, the update related to the simulation tick may be skipped). This may allow game server 210 (or publication component 218) to send information about a change in the game state (i.e., send updated game state data), which may be caused, for example, by another player pressing a button, not only at a next network tick, but instead as soon as game server 210 learns about the change. Such embodiments may be referred to herein as “tick-less.” Using a tick-less approach may result in a reduction in perceived lag (often referred to as “input lag”), which is the delay between an action occurring and the same action being displayed to a user at a game client (e.g., client computer system 110). In some implementations, even if updates are not sent at network ticks, game server 210 may still be configured to use “virtual ticks,” which may correspond to regular intervals on game server 210 and client computer system 110, but do not directly correspond to a time when packets are sent.

In various implementations, game server 210 may be configured to use UDP-based compression. In such implementations, publication component 218 may be configured to send an identifier (“ID”) of the packet in each of UDP packet from game server 210 to client computer system 110. In such implementations, the ID may be incremented in each subsequent packet. In various implementations, client computer system 110 may then be configured to send an acknowledge (“ACK”) field, with the ID of the previously received packet, back to the game server 210. Such “ACK” field may be sent either in a separate packet, or as an additional field in a packet sent for other reasons (this practice is sometimes referred to as “piggybacking”). Game server 210 may be configured to store a history of previously published states, each with their corresponding ID. Then, in order to reduce amount of data being sent, publication component 218 may be configured to send updated game state data within UDP packets in which the updated game state is encoded using the state with last-acknowledged-ID as a reference. For example, game server 210 may be configured to use one or more of the techniques described in “Snapshot Compression,” by Glenn Fiedler, posted Jan. 4, 2015, and available at https://gaffcrongames.com/post/snapshot_compression/(last visited May 16, 2024). In another example, game server 210 may be configured to encode an updated game state by referencing the previously provided update using one or more techniques described in U.S. patent application Ser. No. 18/438,702, including “temporal encoding,” which may correspond to encoding fields or values by referencing the same object in a base version of the updated game state data.

To encode the updated game state using temporal encoding, game server 210 may be configured to encode a field or value by referring to the same object in a base version of the updated game state data. As used herein, the same object may comprise an object having the same position within the hierarchy of the structured data. For example, for each game state update, a UDP packet is sent, and the published game state that can be observed after the update for a particular UDP packet with “ID=X” may be referred to as “state with ID=X.” To encode a next updated game state using temporal encoding, game server 210 may be configured to encode the updated game state data using “state with ID=last-received-ACK” as a “base.”

In various implementations, game server 210 may be configured to use “predictive coding” to reduce the amount of data being sent. For example, if game server 210 needs to publish information about coordinates and/or velocities of a three-dimensional object, game server 210 may be configured to use predictive coding to encode the data indicating the coordinates and/or velocities of that three-dimensional object in the publication issued by publication component 218. For example, in some implementations, game server 210 and/or client computer system 110 may store one or more “velocity profiles” for a three-dimensional object. In some implementations, game server 210 and/or client computer system 110 may be configured to store one or more velocity profiles per type of object, player character (PC) or non-player character (NPC). For example, velocity profiles may be defined by a race of PC or NPC. Typically, a velocity profile may be a function defining how velocity of an object changes when the object moves in a particular manner. For example, there may be a first velocity profile when a particular type of character is walking, and a second velocity profile when that particular type of character is running. In various implementations, a velocity profile may comprise a piecewise linear function (which may be defined, for example, by defining pieces of the function).

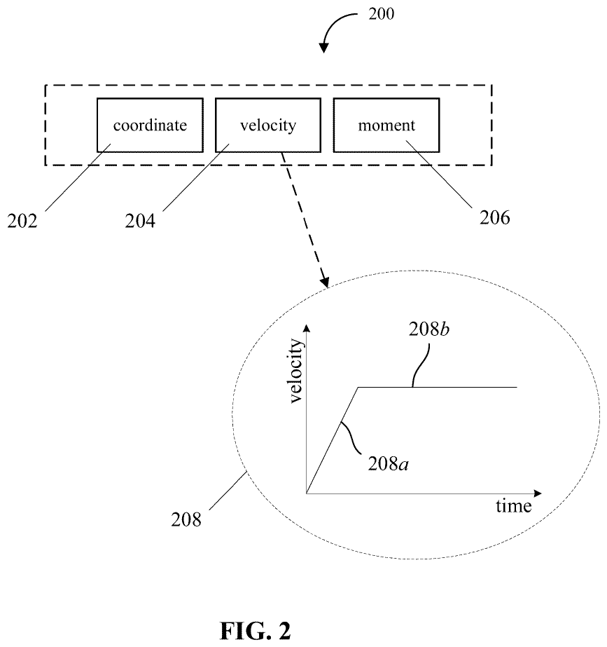

For example, FIG. 2 depicts a block diagram of example object game state information 200 as published by a game server and associated with a particular game object, according to one or more aspects described herein. For example, published object game state information 200 may include coordinate data 202, velocity data 204, and moment data 206. In some implementations, moment data 206 may comprise “TObj,” which indicates the moment in time to which coordinate data 202 and velocity data 204 correspond. In some implementations, coordinate data 202 may denote coordinates of the object as of the moment TObj. In some implementations, velocity data 204 may comprise (or indicate) one or more of velocity of the object as of the moment TObj and a “velocity profile,” which is associated with a current movement by the object. In some implementations, the velocity profile may be represented as is, or as a reference to or an identifier (ID) of a “velocity profile” asset which is embedded into both publisher (e.g., game server 210) and subscriber (e.g., client computer system 110). In some implementations, a velocity profile may be derived by the subscriber from other publishable data. For example, a velocity profile may be derived by the subscriber from a character type or race combined with an indication of its type of movement (e.g., an “is_running” flag). As depicted in FIG. 2, velocity profile 208 may comprise a piecewise linear function. In the non-limiting example depicted in FIG. 2, velocity profile defines a linearly growing velocity (or speed) 208a when object is gradually speeding up and a stabilized velocity 208b when a certain limit is reached. In some implementations, a velocity profile may also include a slowing down velocity. In some implementations, velocity profile 208 may be based on a polynomial function, a spline interpolation, and/or other techniques now known or future developed.

In some implementations, one or more velocity profiles may be embedded into a publisher (or game server 210) and/or a subscriber (or client computer system 110). For example, one or more velocity profiles 208 may be embedded into a publisher (or game server 210) and/or a subscriber (or client computer system 110) in the form of piece-wise pieces for piece-wise linear function, in the form of polynomial coefficients for polynomial functions, and/or in the form of interpolation points and/or end conditions for spline interpolation.

In various implementations, based on (a) current coordinates, (b) current velocity and direction, and (c) type of velocity profile (e.g., walk or run) from a corresponding velocity profile obtained from game server 210, client computer system 110 may be configured to calculate a future velocity and set of coordinates for an object, so long as conditions do not change (i.e., the object running into a wall, player input changing the movement of the object, and/or another change in conditions). For example, in various implementations, gameplay prediction component 118 may be configured to calculate velocity of an object at a future point “t” as:

$$v ( t ) = vp ( inv p ( v ( TObj ) ) + ( t - TObj ) ) ,$$

where a velocity as of moment TObj is denoted as “v(TObj)”, vp( ) is velocity profile function, and invp( ) is an inverse of the velocity profile function. In some implementations (especially those using velocity profiles which are more complicated than a simple linear piece-wise function), gameplay prediction component 118 may be configured to calculate the formula above via calculating changes to coordinates by integration of v(t), or by simulation. In some other implementations, instead of publishing object velocity v(TObj) as of the moment TObj, a “time since beginning of the velocity profile as of moment TObj” (denoted as “vt(TObj)”) may be published. In such implementations, v(t) may be calculated as:

$$v ( t ) = vp ( vt ( TObj ) + ( t - TObj ) ) .$$

In some implementations, if the calculations show that a target point is reached, the assumed velocity at the target point may be 0, and the coordinates may remain unchanged at the target point. In some implementations, a next target point may be additionally published for the same object (for example, as a part of the object game state information 200). In such implementations, upon reaching the target point, the object may be assumed to move from the previous target point towards the next target point. This may help to significantly reduce latencies in case network packets are lost around the time when the object is reaching the target point. In some implementations, if the game object takes some time to turn, turning time may be calculated for the object to turn from the orientation or heading of the object when arriving at the previous target point to the orientation or heading corresponding to the path from the target point to the next target point. In some implementations, the “time to turn” for a given object may be a fixed time. In other implementations, the time to turn may be calculated based on the angle between the path the object was on when arriving at the target point and the path the object will take from the target point to the next target point.

In various implementations, publication component 218 may be configured to publish game state data with object game state information 200. For example, the game state data may include coordinate data 202 as of moment of time “TObj,” velocity data 204 as of moment of time “TObj,” and moment data 206 which describes moment of time “TObj.” Using stored velocity profiles or velocity profiles obtained from game server 210, this information may be sufficient to calculate coordinates and velocities of an object for any moment t>=TObj (both times expressed from the perspective of game server 210), assuming that a movement of an object does not change. For example, calculating velocity v(t) at any given moment t may be performed using the methods described with respect to calculations of v(t) above, and calculating coordinates may be performed using published coordinates and integration of v(t) over time, or using simulation. If the movement of the object does change, game server 210 may be configured to publish updated information regarding the movement or position of the object (e.g., updated object game state information 200) within updated game state data included in a publication issued from game server 210 and received by client computer system 110. However, if the movement of the object does not change, updated game state data need not include additional information regarding the movement or position of the object. Accordingly, publication component 218 may be configured to publish information (which may correspond to sending network packets) only when necessary. In other words, as long as there are no changes related to the movement or position of the object, game server 210 may not re-publish game state data while objects continue to move in client computer system 110.

In some implementations, game server 210 may be configured to use “predictive coding” (e.g., to enable calculation of coordinates and/or velocity of an object) not based on a velocity profile 208, but instead based on a physical formula. For example, when an object is a free-falling object, game server 210 may publish its coordinates and velocity as of moment TObj, but calculate velocities based on free-falling kinematic equations (e.g., based on v(t)=v(TObj)+g*(t−TObj)), where g is gravitational acceleration.

In some implementations, publication component 218 may be configured to re-publish a “current moment TObj” to reduce reliance on the accuracy of the clock in client computer system 110. In other implementations, however, publication component 218 may not publish “current moment TObj” or any updated game state data for a given object. For example, when simulation indicates that all data for a specific object remains the same, game server 210 may not publish updated game state data for that object. In some implementations, coordinates and/or velocities for an object may be calculated at both client computer system 110 and game server 210.

In various implementations, publication component 218 of game server 210 may be configured to publish a target point (i.e., where object is moving to) and a next target point (i.e., point that object will be moving to after reaching current target point). In some implementations, publication component 218 may be configured to publish a target point and a next target point in addition to current coordinates and directions for an object. Based on the foregoing published game state data, client computer system 110 may be configured to render smoother movement in the event packets are lost. For example, when an object is a character, and if pathfinding is used for the character on game server 210, published game state data may help client computer system 110 to render smoother movement when there is a packet lost while character is moving around the turning or target point. In some implementations, publication component 218 may be configured to publish more than one “next point,” each representing a subsequent point that an object will traverse unless publication changes.

In various implementations, publication component 218 may be configured to publish a “current moment T” in some UDP packets sent from game server 210 to client computer system 110. This “current moment T” may correspond to the moment T which is observed on the game server 210 at (or near) the point in time when the packet is sent. In some implementations, this moment T may correspond to the server time, while in some other implementations it may correspond to the game time (i.e., the time observed within the game as it is played). In some implementations, “current moment T” may be a part of published data. In other implementations, “current moment T” may not be a part of published data, but may rather be included in UDP packets. In some implementations, “ID of packet” may be used in lieu of “current moment T.” For example, some of the published updates may contain only “current moment T” information. Such updates may in turn lead to sending UDP packets with only this information (only a few bytes), which may be referred to herein as “almost-empty packets.”

In some implementations, because “almost-empty packets” are not carrying useful information, game server 210 may be configured to skip sending them. In other implementations, it may be necessary to send “almost-empty packets” once in a while so that client computer system 110 may discern whether there are no changes in game state, or whether the changes are lost due to network packet loss. As such, in some implementations, game server 210 may be configured to send almost-empty packets periodically or send only a certain percentage of almost-empty packets. For example, game server 210 may be configured to send only every fifth almost-empty packet. These almost-empty packets that are indeed sent and not skipped may be referred to herein as “keep-alive packets.” In some implementations, if particular “current moment T” information is not included in a publication (i.e., within updated game state data), game server 210 may still send “almost-empty packets” or “keep-alive packets” to enable client computer system 110 to determine whether there have been no changes to the game state or whether the changes are lost due to network packets loss.

In some implementations, game server 210 may be configured to use keep-alive packets to “piggy back” certain data. For example, game server 210 may use keep-alive packets to include “slow” data. As used herein, slow data may include information such as “likely to appear” data as described in U.S. patent application Ser. No. 18/630,409, and/or next-point data described above. In some implementations, slow data may be delivered using “best effort” (i.e., sent only if there is space within keep-alive packets). In such implementations, “space” may be calculated to ensure that the packet fits within some pre-defined size. For example, the pre-defined size may be determined based on the Maximum Transmission Unit (“MTU”) or based on a size that is likely to pass through routers without delays. For example, on some networks, this pre-defined size may be set to a number between 500 and 1500 bytes. In some implementations, slow data may have a limit on how long it may be delayed without sending it. In such implementations, slow data may be piggy-backed until a delay limit is reached, and a separate packet may be issued afterwards. In other implementations, game server 210 may increase relative priority of slow data as its delay limit is becoming closer.

In some implementations, when providing information for a given object (e.g., such as object game state information 200 including velocity and coordinate data), game server 210 may be configured to incorporate object movements represented by “macro animations.” For example, macro animations may include animations such as a “jumping over a railing” animation, which may take significant time and move character significantly in the coordinate space. In such implementations, for a movement segment involving a given macro animation, game server 210 may be configured to represent a current position of an object with a frame number within animation at “moment TObj,” and re-calculate the frame number at current moment in time using techniques described herein. In some implementations, key-frame animation may be used, and a pair of “(keyframe_number, time_from_keyframe)” at the moment TObj may be published. In some implementation, in addition to (or instead of) calculating current position of the object, other animation parameters (such as limb angles or skinned-mesh matrices) may be calculated using a similar approach.

In some implementations, game server 210 may need to retransmit packets that were lost. In implementations in which game server 210 sends updates on each network tick, UDP compression packets described above (in which data is encoded by reference to “last-received-ACK” packet) may effectively act as retransmits, allowing client computer system 110 to reconstruct the current state as soon as any packet is received. In “tick-less” implementations in which game server 210 sends updates as necessary, publication component 218 may be configured to send retransmits explicitly. For example, in some implementations, publication component 218 may be configured to send retransmits on timeout (i.e., if ACK is not received). However, in some implementations, if the timeout is related to round-trip time, this approach may lead to significant delays. In other implementations, publication component 218 may be configured to send two or more copies of the same packet simultaneously. For example, publication component 218 may be configured to send two or more copies of the same packet simultaneously as described in U.S. patent application Ser. No. 15/640,565, entitled “SYSTEMS, APPARATUSES AND METHODS FOR NETWORK PACKET MANAGEMENT,” filed Jul. 2, 2017, the contents of which are hereby incorporated by reference herein in their entirety. In some implementations, publication component 218 may be configured to send two or more copies of the same packet with a delay between the respective copies, as similarly described in U.S. patent application Ser. No. 15/640,565. In some implementations, publication component 218 may be configured to stop sending copies of the packet as soon as acknowledgement of receipt is received. In other embodiments, if another update is to be sent or if acknowledgement of receipt of a packet is received from client computer system 100 while the most recent update is still unacknowledged, publication component 218 may be configured to issue a new packet including the difference between current state and the last acknowledged packet (e.g., using UDP compression as described herein).

In some implementations, if all the data in a pending update is “slow” data, publication component 218 may be configured re-transmit relevant packets using a different policy. For example, publication component 218 may be configured to re-transmit such packets only if estimated round-trip time has elapsed and acknowledgement for such a packet was not received. In some implementations, publication component 218 may use any of the techniques known in the art for TCP retransmits.

In various implementations, update management component 116 may be configured to facilitate communication with, and manage updates received from, game server 210. In various implementations, update management component 116 may be configured to synchronize the current game state with the game server using UDP packets. In various implementations, update management component 116 may be configured to run a client application on client computer system 110. For example, FIG. 3 depicts a block diagram of an example client application 300 used to synchronize a game state between game server 210 and client computer system 110, according to one or more aspects described herein. In various implementations, client application 300 may include a UDP socket 304, a virtual packet arrival calculator 306, a server-T generator 308, a server-T calculator 310, a reconciler 330, a renderer 340, and/or one or more other components. In various implementations, UDP packets may arrive at client application 300 via UDP socket 304. In some implementations, UDP socket 304 may comprise a Berkeley UDP socket and/or another application programming interface (API) suitable for receiving UDP packets. In various implementations, subscription 305 may comprise an intermediate copy of the publisher's data (i.e., data obtained from game server 210). As used herein, a “subscription” may correspond to a “publication” issued by a game server 210 and comprise such a publication as it is received and maintained on client computer system 110.

When packet arrive at client computer system 110 (e.g., via client application 300), due to differences in delay of packets over the internet, some packets sent at regular intervals, may not arrive uniformly distributed in time. This phenomenon is often referred to as “jitter.” When rendering information in the packets as it arrives, jitter may cause unwanted visual effects, such as uneven movement of objects. To reduce these effects, it is common to provide a steady stream of updates coming at regular intervals and to use a “jitter buffer” (also sometimes referred to as a “dejitter buffer”). However, jitter buffers may inherently introduce additional lag.

To avoid such lag, client application 300 may be configured to rely on a given publication being sufficient to calculate positions of objects at any moment t>=TObj (both times expressed from the perspective of game server 210), as described herein. In such implementations, client application 300 does not need to delay packets using a “jitter buffer.” Instead, as soon as a packet arrives, client application 300 may be configured to apply it immediately to obtain an updated copy of publisher's data within subscription, which, as described herein, may be further used to re-calculate object positions for a screen frame to be rendered. Note that as rendering may be based on the positions calculated for the game time corresponding to the client-side time when rendering happens (and, unlike traditional implementations, not using data from the last received packet directly), such implementations may avoid any uneven movement. In addition, for those objects for which published data did change, client application 300 may be configured to start applying it as soon as possible, which may reduce the lag. Moreover, in some implementations, client application 300 may send such updates not necessarily on “network tick” moments, but as soon as game server 210 learns about them, as described herein, thereby further reducing the lag by up to one network tick.

In various implementations, server-T generator 308 may be configured to provide calculations of reference time. For example, server-T generator 308 may be configured to calculate a game server 210 time as seen at client computer system 110, which may also be referred to herein as “server-T.” The game server 210 time as seen at client computer system 110 (or “server-T”) may run at the same speed as a clock of game server 210, but may be delayed by certain delta time ST. In some implementations, server-T generator 308 may be implemented based on a clock of client computer system 110 (not shown in FIG. 3). For example, server-T generator 308 may be configured to calculate server-T by averaging an arrival time of the last N packets and adding the well-known time period of “network tick” (as measured by a clock of client computer system 110). However, in some implementations, this approach may be undesirable due to varying jitter of arriving packets and due to frequency skew between a clock speed of game server 210 and a clock speed of client computer system 110.

In various implementations, server-T generator 308 may function as a software Phase-Locked Loop (PLL). In such implementations, server-T generator 308 may include a phase comparator 308a, a loop filter 308b, and a numerically controlled oscillator (NCO) 308c. In some implementations, phase comparator 308a may be configured to compare an expected arrival of a packet and a predicted arrival of a packet, loop filter 308b may be an integrator (such that frequency of NCO 308c may be changed very slowly), and NCO 308c may be configured to take an output of loop filter 308b and change its frequency accordingly. In some implementations, NCO 308c may be implemented in an event-driven manner by calculating time for a next “tick” of NCO based on output of loop filter 308b. In other implementations, server-T generator 308 may be considered either a software Phase-Locked Loop (PLL) or a software Delayed-Locked Loop (DLL). Notably, all references to PLL included herein may be replaced with Delayed-Locked Loop (DLL) or a similar technique.

In some implementations, for example, when packets may be sent immediately (not only on network ticks), client application 300 may still be configured to use a PLL-based server-T generator 308, but may also adjust arrival time of packet in virtual packet arrival calculator 306. In various implementations, virtual packet arrival calculator 306 may be configured to adjust the arrival time of a packet, for example, by taking “current moment T” from an arriving packet, and by delaying the packet for the purpose of feeding its arrival time to server-T generator 308 (but not for applying it to the subscription) by a difference between “current moment T” and “time 1 when the next tick would happen.” For example, assuming an implementation in which there are ticks (or “virtual ticks”) available for every 20 ms starting from T=0, and “current moment T” was sent on the moment at T=234 ms, virtual packet arrival calculator 306 may be configured to delay feeding the next input to server-T generator 308 for roughly 6 ms. Indeed, because the next tick is expected at 240 ms, and the packet indicates it corresponds to a moment at 234 ms, virtual packet arrival calculator 306 may delay it for 6 ms until the next tick.

In other implementations, the same effect may be achieved by applying the packet to server-T generator 308 immediately, but with a “virtual delay” parameter (e.g., 6 ms), which may be taken into account by server-T generator 308. For example, server-T generator 308 may treat the packet as if it arrived at 6 ms later. For example, if a PLL-based server-T generator 308 is used, phase comparator 308a may process the “virtual delay” when calculating phase difference. In such case, loop filter 308b may also process “virtual delay” when filtering (typically integrating) the output of phase comparator 308a.

In various implementations, client application 300 may be configured to use certain techniques to speed up PLL synchronization. In some implementations, client application 300 may be configured to synchronize output of NCO 308c with an average of the first N incoming packets, where N>=1. For example, client application 300 may be configured to synchronize a first output of NCO with an average of the first N incoming packets. In other implementations, client application 300 may be configured to modify loop filter 308b to increase an impact of first packets. For example, client application 300 may increase coefficient k for integrating phase shift into loop filter 308b to gradually reduce to lower values as the time passes. In some implementations, client application 300 may be configured to allow server-T generator 308 to send “tick” timer events at regular intervals and/or provide an API to indicate a current server-T.

In various implementations, there may be situations where it is beneficial to have frames rendered at externally-specified moments. In such situations, client application 300 may be configured to use V-sync to render frames and address potential “screen tearing” issues. Vertical synchronization (or V-sync) is a graphics technology designed to sync a game's frame rate with the refresh rate of a gaming monitor. For example, when a “V-sync event” occurs (i.e., when there is a need to immediately render a frame), server-T calculator 310 may request a current server-T from server-T generator 308. Then, this information may be fed to a scene “as of server-T” calculator 320. In various implementations, scene “as of server-T” calculator 320 may be configured to take a current server-T from server-T calculator 310, and (for each object) use published information as of TObj to calculate positions of each of the objects and determine the entirety of three-dimensional scene as of moment corresponding to server-T. In various implementations, this scene may further be used for rendering. While with traditional implementations, using V-sync usually increases input lag, with the methods described herein, it may provide additional visual smoothness without any increase of the input lag.

In various implementations, there may be a situation where rendering may be synchronized according to a pre-defined timing. For example, there may be situations where rendering may be synchronized using NVIDIA® G-Sync® or AMD Freesync™. In such implementations, client application 300 may be configured to render frames at “tick” timer events generated by server-T generator 308. In various implementations, client application 300 may be configured to use a PLL (e.g., via server-T generator 308) to “multiply” frequency of the input. For example, client application 300 may use original frequency of NCO 308c close to a desired multiplied frequency or any other suitable PLL frequency multiplication technique known in the art. For example, client application 300 may have a frequency of “network ticks” or “virtual ticks” at 20 per second, and a frequency of server-T and rendering frames multiplied by 3 to render frames at 60 fps (or multiplied by 6 to render frames as 120 fps). In such implementations, if a desired frame frequency is not a multiple of a frequency of “network ticks” or “virtual ticks,” client application 300 may be configured to use a separate frequency generator (with a desired frame frequency) to initiate rendering (in lieu of V-sync).

In some implementations, a packet with the update packet may be delayed (for example, because of Internet delays) and may arrive after the “stale” information has already been rendered. For example, rendering based on “stale” information may comprise rendering an object based on information obtained in a previous update that no longer applies. In such cases, a situation may arise when data which came from game server 210 does not match the rendered information (which was generated “as of server-T”). In this case, reconciler 330 of client application 300 may be configured to reconcile between an already-rendered state and updated game state data (issued by game server 210 as a publication and implemented in client computer system 110 as a corresponding subscription). In some implementations, to avoid abrupt movements of an object, client application 300 may be configured to blend (or combine) an old (i.e., already-rendered) trajectory with a new (i.e., updated from the subscription) trajectory. For example, client application 300 may blend using the following formula:

$$blended = old * blending\_factor + new * ( 1 - blending\_factor ) ,$$

in which “blending_factor” may gradually change from 0 (corresponding to 100% “old” trajectory) to 1 (corresponding to 100% “new” trajectory) over some pre-defined time (e.g., 1 second). In other implementations, reconciler 330 may use any of the methods for reconciling between an already-rendered state and updated game state data described in “Development and Deployment of Multiplayer Online Games, Vol. I: GDD, Authoritative Servers, Communications (Development and Deployment of Multiplayer Games)” by “No Bugs” Hare, translated by Sergey Ignatchenko, and published Jul. 1, 2017, the contents of which are hereby incorporated by reference herein in their entirety. Notably, the approach described herein may achieve similar results as client-side Interpolation, Dead Reckoning (a.k.a. client-side Extrapolation) as described in “Development and Deployment of Multiplayer Online Games, Vol. I: GDD, Authoritative Servers, Communications (Development and Deployment of Multiplayer Games)” and “Fast-Paced Multiplayer (Part III): Entity Interpolation” by Gabriel Gambetta, available at https://www.gabrielgambetta.com/entity-interpolation.html (last visited May 13, 2024). However, the techniques described herein do so in a different manner and provide substantial benefits, including both reduction in lag and seamless integration with V-sync.

In various implementations, one or more other communication protocols may be used as a transport instead of UDP packets. In some implementations, IP packets may be used as a transport instead of UDP packets. In other implementations, Unreliable Datagram Extension to QUIC may be used as a transport instead of UDP packets. In certain implementations, the same QUIC connection may be used to download assets. For example, a similar QUIC connection may be used as a transport as is described in U.S. patent application Ser. No. 18/630,409. For example, in some implementations, QUIC streams within QUIC connection may be used as a transport instead of UDP packets, and QUIC unreliable datagrams (as defined by Unreliable Datagram Extension) may be used for “publishing” data. In some implementations, low-latency TCP chunks sent over multiple TCP connections may be used as a transport instead of UDP packets. For example, instead of UDP packets, game server may use as a transport low-latency TCP chunks sent over multiple TCP connections as described, for example, in “(Almost-) Zero-Additional-Latency UDP-over-TCP” by “No Bugs” Hare, translated by Sergey Ignatchenko, posted Mar. 21, 2017, and available at http://ithare.com/almost-zero-additional-latency-udp-over-tcp/(last visited May 13, 2024). In other implementations, Real-Time Transport Protocol (RTP) packets or WebRTC packets or Stream Control Transmission Protocol (SCTP) messages may be used as a transport instead of UDP packets.

In some implementations, game server 210 may send messages over a stream-oriented transport (such as TCP) instead of sending UDP packets. In some implementations, game server 210 may try sending UDP packets and use TCP as a fallback, if UDP connection is unsuccessful or its characteristics (e.g., latency, jitter, or packet loss) are below a certain threshold limit.

In some implementations, using the one or more techniques or components described herein, game server 210 may be configured to use “predictive coding” to reduce the amount of data being sent in additional (or alternative) ways beyond those described herein. In some implementations, a physics simulation (e.g., a rigid physics simulation) or some AI (such as inter-NPC collision avoidance AI) may be added to scene “as of server-T” calculator 320. Then, game server 210 may be configured to stop publishing some or all of the updates simulated by scene “as of server-T” calculator 320. Nevertheless, game server 210 may still need to publish updates relevant to changes to the published state introduced by other players. Unlike with lockstep algorithms, any strict deterministic approaches may not be necessary because it would be difficult, more specifically, for cross-platform clients when floating-point calculations are used. Instead, in some implementations, reconciler 330 may be used to sort out differences in calculations between client computer system 110 and game server 210. In some implementations, a publisher (or game server 210) may publish some (but not necessarily all) simulated updates, so that when reconciliation occurs, accumulated errors based on different calculations from client computer system 110 and game server 210 do not cause observable visual effects.

While various operations are described herein as being performed by the client computer system 110 or the game server 210 (or one or more components of client computer system 110 or game server 210), it is to be understood that, unless explicitly indicated otherwise, each of the one or more operations described herein as being performed by a client computer system 110 could be performed by a game server 210 and that each of the operations described herein as being performed by a game server 210 could be performed by a client computer system 110.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., client computer system 110, processor(s) 112, game server 210, processor(s) 212, and/or other components). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor(s) 112, 212, information received remotely, and/or other information that enables system 100 to function properly. For example, electronic storage 130 may store standard three-dimensional meshes or models, information relating to one or more three-dimensional meshes or models, velocity profiles, publication and/or subscription data, and/or other information related to the systems and methods described herein.

Game server 210 may comprise a remote server configured to provide publications and game state data related to an online game comprising three-dimensional virtual scenes to client computer system 110. In some implementations, game server 210 may be configured to provide to client computer system 110 publications related to an online game that include cause three-dimensional object(s) to be rendered within a virtual scene. For example, a publication may cause a virtual scene to be constructed comprising at least one object to be generated based on a generic asset, a base texture, and assets received in response to a request. In various implementations, game server 210 may be configured as a server device (e.g., having one or more server blades, processors, etc.) and/or as another device capable of providing publications and game state data related to an online game to client computer system 110.

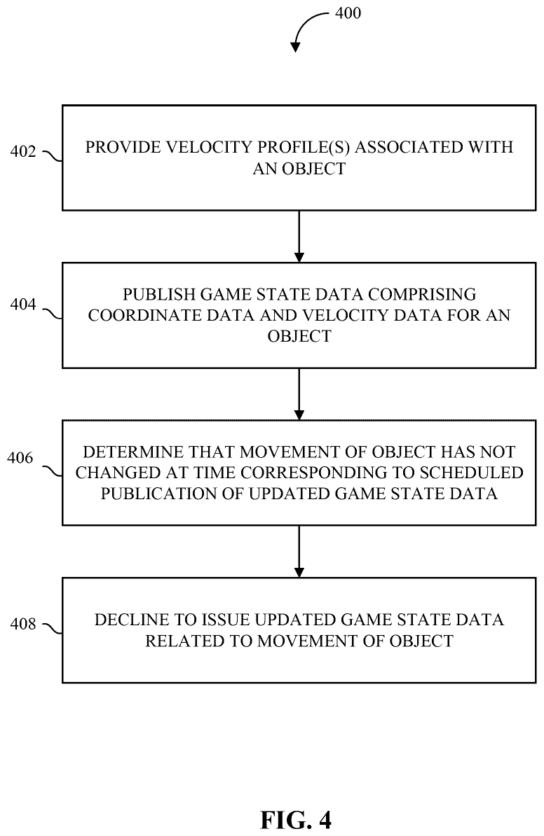

FIG. 4 illustrates an example of a process 400 for communicating game state data used to render three-dimensional objects within a virtual scene, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components of game server 210 or client computer system 110 described in detail above.

In an operation 402, process 400 may include providing, by a game server, one or more velocity profiles associated with an object for downloading by one or more client computer systems. In some implementations, at least one of the one or more velocity profiles may comprise a piecewise linear function. In some implementations, at least one of the one or more velocity profiles may comprise a polynomial function. In some implementations, at least one of the one or more velocity profiles may comprise a spline interpolation. In some implementations, velocity profiles may be represented as one of the assets in the game, where the assets may be either downloaded together with the client, or on-demand. For example, game assets (such as velocity profiles) may be downloaded with a game application client run on the client computer system and/or on demand using one or more techniques described in U.S. patent application Ser. No. 18/616,967, entitled “SYSTEMS AND METHODS FOR IMPROVING ASSET DOWNLOAD TIME USING FORWARD ERROR CORRECTION,” filed Mar. 26, 2024; U.S. patent application Ser. No. 18/630,409, entitled “SYSTEMS AND METHODS FOR INCREMENTAL DYNAMIC LOADING OF GAME ASSETS,” filed Apr. 9, 2024; and/or U.S. patent application Ser. No. 18/630,605, entitled “SYSTEMS AND METHODS FOR REDUCING ASSET DECOMPRESSION TIME,” filed Apr. 9, 2024, the contents of each of which is hereby incorporated by reference herein in its entirety.

In an operation 404, process 400 may include publishing, by the game server game state data at a first time for use by the one or more client computer systems to render a virtual scene within an online game. In various implementations, the game state data may include at least coordinate data for the object at the first time and velocity data for the object at the first time. In some implementations, the game state data may further include a target point and one or more next points each representing a subsequent point that the object will traverse after the target point unless updated game state data is received. In various implementations, the published game state data may be included within one or more User Datagram Protocol (UDP) packets. In some implementations, the game state data may be published by the game server immediately in response to input received. For example, the game state data may be published by the game server immediately in response to input that prompts the game state data to be updated. In some implementations, publishing the game state data immediately may comprise publishing the game state data without waiting for a subsequent network tick.

In an operation 406, process 400 may include determining, by the game server, that movement of the object has not changed at a second time corresponding to a scheduled publication of updated game state data. In an operation 408, process 400 may include the game server declining to include coordinate data for the object at the second time or velocity data for the object at the second time in the updated game state data responsive to the determination that the movement of the object has not changed since the first time. Put differently, the game server may be configured to not include coordinate data for the object at the second time or velocity data for the object at the second time in the updated game state data responsive to the determination that the movement of the object has not changed since the first time. In various implementations, the one or more client computer systems are instead configured to determine coordinates and a velocity of the object at the second time based on the one or more velocity profiles, the coordinate data for the object at the first time, and the velocity data for the object at the first time. In various implementations, the game server may be configured to decline to provide updated game state data when movement of the object has not changed because the previous game state data includes all the information necessary to calculate a position of an object at an arbitrary future point in time. In some implementations, such information may include a frame number of an animation representing a current position of the object within the animation at that time. In some implementations, the updated game state data, if present, may be encoded by reference to a last acknowledged version of the game state data.

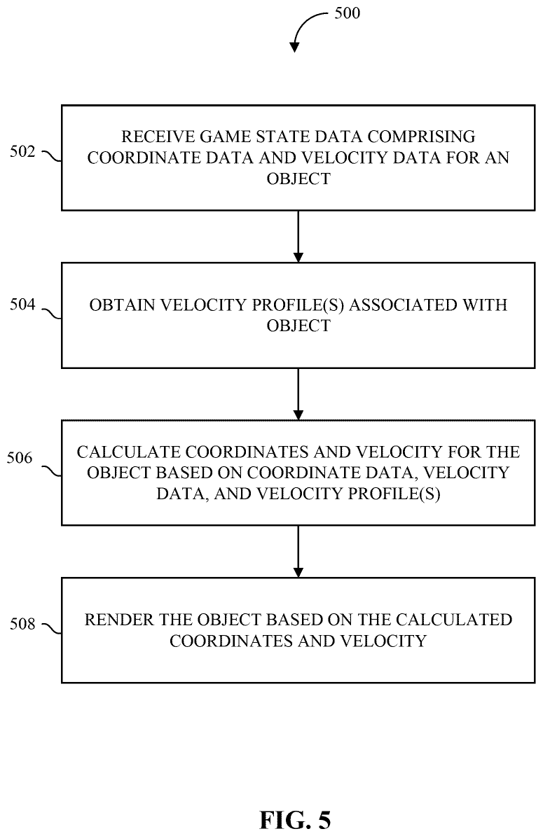

FIG. 5 illustrates an example of a process 500 for updating a game state based on information related to a moving object received from a game server, according to one or more aspects described herein. The operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components of client computer system 110 described in detail above.

In an operation 502, process 500 may include receiving, by a client computer system, game state data used to render a virtual scene within an online game. In various implementations, the game state data may include at least coordinate data for an object at a first time and velocity data for the object at the first time. In some implementations, the game state data may further include a target point and one or more next points each representing a subsequent point that the object will traverse after the target point unless updated game state data is received. In various implementations, the published game state data may be included within one or more User Datagram Protocol (UDP) packets. In some implementations, the updated game state data may be encoded by reference to a last received (and/or acknowledged) version of the game state data.

In an operation 504, process 500 may include obtaining, by the client computer system, one or more velocity profiles associated with the object. In some implementations, at least one of the one or more velocity profiles may comprise a piecewise linear function. In some implementations, at least one of the one or more velocity profiles may comprise a polynomial function. In some implementations, at least one of the one or more velocity profiles may comprise a spline interpolation.

In an operation 506, process 500 may include calculating, by the client computer system, coordinates and a velocity for the object after the first time based on the coordinate data for the object at the first time, the velocity data for the object at the first time, and at least one of the one or more velocity profiles. In some implementations, the client computer system may be configured to calculate coordinates and a velocity based further on a target point and one or more next points included within the game state data.

In an operation 508, process 500 may include rendering, by the client computer system, the object within a virtual scene of an online game based on the calculated coordinates and velocity for the object after the first time. In various implementations, the client computer system may be configured to render a virtual scene without receiving updated game state data because the previous game state data includes all the information necessary to calculate a position of an object at an arbitrary future point in time. In some implementations, such information may include a frame number of an animation representing a current position of the object within the animation at that time, and/or a (keyframe_number, time_from_keyframe) pair. In some implementations, the game state data may be immediately applied to previously updated data received from the game server and used to and used to render a virtual scene.

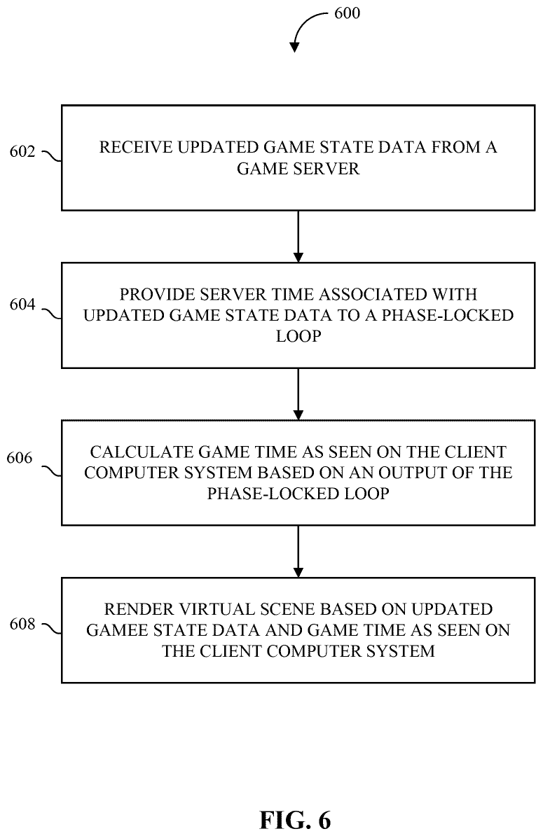

FIG. 6 illustrates an example of a process 600 for syncing the receipt of game state data with the rendering of a virtual scene based on the received game state data, according to one or more aspects described herein. The operations of process 600 presented below are intended to be illustrative and, as such, should not be viewed as limiting. In some implementations, process 600 may be accomplished with one or more additional operations not described, and/or without one or more of the operations discussed. In some implementations, two or more of the operations of process 600 may occur substantially simultaneously. The described operations may be accomplished using some or all of the system components of client computer system 110 described in detail above.

In an operation 602, process 600 may include receiving, by a client computer system, updated game state data from a game server to be used to render a virtual scene within an online game. In an operation 604, process 600 may include providing, by the client computer system, a server time associated with the updated game state data to a phase-locked loop. In some implementations, the phase-locked loop may be implemented at least in part by a phase comparator, a loop filter, and a numerically controlled oscillator (NCO). In various implementations, a virtual delay is used to account for uneven packet sending. For example, the virtual delay may be based on a difference between the server time associated with the updated game state data and a time corresponding to a next scheduled (or well-defined) moment when movements are simulated within the online game. In some implementations, the server time associated with the updated game state data may be delayed based on the virtual delay prior to being provided to the phase-locked loop. In other implementations, the phase-locked loop may be configured to treat the packet as delayed based on the virtual delay. For example, the phase comparator may be configured to process the virtual delay when calculating phase difference. In some implementations, the loop filter may also process the virtual delay when filtering the output of the phase comparator. In some implementations, synchronization of the receipt of the updated game state data with the rendering of the virtual scene may be sped up by syncing output of the NCO with an initial set of packets. In other implementations, synchronization of the receipt of the updated game state data with the rendering of the virtual scene may be sped up by increasing an impact of an output of the phase comparator on the loop filter for an initial set of packets.

In an operation 606, process 600 may include calculating, by the client computer system, a game time as seen on the client computer system (i.e., server-T) based on an output of the phase-locked loop. In some implementations, the time of rendering may be determined using vertical synchronization (V-sync).

In an operation 608, process 600 may include rendering, by the client computer system, a virtual scene based on the updated game state data and the game time as seen on the client computer system. In various implementations, rendering the virtual scene based on the updated game state data and the game time as seen on the client computer system at the time of rendering may comprise calculating coordinates for an object based on the game time as seen on the client computer system, and rendering the object within the virtual scene based on the calculated coordinates.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112, 212 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112, 212 as well as data that may be manipulated by processor(s) 112, 212. The electronic storage may comprise floppy disks, hard disks, optical disks, tapes, or other storage media for storing computer-executable instructions and/or data.

Although illustrated in FIG. 1 as a single component, client computer system 110 and game server 210 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112, 212 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 210 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 210 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 210. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 210. Indeed, while described herein as a single interface 102 for simplicity, interface 102 may include one or multiple physical and/or virtual interfaces via which packets may be sent from client computer system 110 to game server 210, and vice versa. For example, multiple connections forming a Local Area Network (LAN), Intranet, or Internet may be used to facilitate communication between client computer system 110 and game server 210.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered example only, and the scope of the invention is accordingly intended to be limited only by the following claims.

1. A computer-implemented method of communicating game state data used to render three-dimensional objects within a virtual scene, the method comprising:
providing, by a game server, one or more velocity profiles associated with an object for downloading by one or more client computer systems;
publishing, by the game server, game state data at a first time for use by the one or more client computer systems to render a virtual scene within an online game, wherein the game state data includes at least coordinate data for the object at the first time and velocity data for the object at the first time; and
determining, by the game server, that movement of the object has not changed at a second time corresponding to a scheduled publication of updated game state data, wherein the game server is configured to not include coordinate data for the object at the second time or velocity data for the object at the second time in the updated game state data responsive to the determination that the movement of the object has not changed since the first time, wherein coordinates and a velocity of the object at the second time are instead determined at the one or more client computer systems based on the one or more velocity profiles, the coordinate data for the object at the first time, and the velocity data for the object at the first time.

2. The computer-implemented method of claim 1, wherein at least one of the one or more velocity profiles comprises a piecewise linear function.

3. The computer-implemented method of claim 1, wherein at least one of the one or more velocity profiles comprises a polynomial function.

4. The computer-implemented method of claim 1, wherein at least one of the one or more velocity profiles comprises a spline interpolation.

5. The computer-implemented method of claim 1, wherein the game state data further includes a target point and one or more next points, the one or more next points each representing a subsequent point that the object will traverse after the target point unless updated game state data is received.

6. The computer-implemented method of claim 1, the method further comprising publishing, by the game server at a third time, updated game state data including at least coordinate data for the object at the third time and velocity data for the object at the third time, wherein the updated game state data further comprises a frame number of an animation representing a current position of the object within the animation at the third time.

7. The computer-implemented method of claim 1, wherein the published updated game state data is included within one or more User Datagram Protocol (UDP) packets.

8. The computer-implemented method of claim 1, wherein the updated game state data is encoded by reference to a last received version of the game state data.

9. The computer-implemented method of claim 1, wherein the game state data is published by the game server immediately in response to input received.

10. The computer-implemented method of claim 9, wherein publishing the game state data immediately in response to input received comprises publishing the game state data without waiting for a subsequent network tick.

11. The computer-implemented method of claim 9, wherein the game state data includes all information necessary to calculate a position of an object at an arbitrary future point in time.

12. A system for communicating game state data used to render three-dimensional objects within a virtual scene, the system comprising:
a game server configured by computer readable instructions to:
provide one or more velocity profiles associated with an object for downloading by one or more client computer systems;
publish game state data at a first time for use by the one or more client computer systems to render a virtual scene within an online game, wherein the game state data includes at least coordinate data for the object at the first time and velocity data for the object at the first time; and
determine that movement of the object has not changed at a second time corresponding to a scheduled publication of updated game state data, wherein the game server is configured to not include coordinate data for the object at the second time or velocity data for the object at the second time in the updated game state data responsive to the determination that the movement of the object has not changed since the first time, wherein coordinates and a velocity of the object at the second time are instead determined at the one or more client computer systems based on the one or more velocity profiles, the coordinate data for the object at the first time, and the velocity data for the object at the first time.

13. The system of claim 12, wherein at least one of the one or more velocity profiles comprises a piecewise linear function.

14. The system of claim 12, wherein at least one of the one or more velocity profiles comprises a polynomial function.

15. The system of claim 12, wherein at least one of the one or more velocity profiles comprises a spline interpolation.

16. The system of claim 12, wherein the game state data further includes a target point and one or more next points, the one or more next points each representing a subsequent point that the object will traverse after the target point unless updated game state data is received.

17. The system of claim 12, wherein the game server is further configured to publish updated game state data at a third time, the updated game state data including at least coordinate data for the object at the third time and velocity data for the object at the third time, wherein the updated game state data further comprises a frame number of an animation representing a current position of the object within the animation at the third time.

18. The system of claim 12, wherein the published updated game state data is included within one or more User Datagram Protocol (UDP) packets.

19. The system of claim 12, wherein the updated game state data is encoded by reference to a last received version of the game state data.

20. The system of claim 12, wherein the game state data is published by the game server immediately in response to input received.

21. The system of claim 20, wherein to publish the game state data immediately in response to input received, the game server is configured to publish the game state data without waiting for a subsequent network tick.

22. The system of claim 20, wherein the game state data includes all information necessary to calculate a position of an object at an arbitrary future point in time.

23-62. (canceled)
